(19) United States
(12) Patent Application Publication
(10) Pub. No.: US 2014/0008270 A1
(43) Pub. Date: Jan. 9, 2014

(54) Reactor for Continuous Regeneration of Catalyst with a Central Gas-Mixing Box

(71) Applicant: IFP Energies nouvelles, Rueil-Malmaison Cedex (FR)

(72) Inventors: Cecile PLAIS, Les Haies (FR); Frederic BAZER-BACHI, Irigny (FR); Eric SANCHEZ, Saint Genis Laval (FR); Eric LEMAIRE, Anse (FR)

(21) Appl. No.: 13/933,583

(22) Filed: Jul. 2, 2013

(30) Foreign Application Priority Data
Jul. 4, 2012 (FR) 1201887

(51) Int. Cl. B01J 38/44

(52) U.S. Cl. CPC B01J 38/44
USPC 208/134; 422/606; 29/402.08

(57) ABSTRACT

The reactor 1 that allows continuous regeneration of catalyst consists of a chamber 2 that comprises an oxychlorination zone superposed on a calcination zone equipped with a pipe for introducing calcination gas and a pipe for injecting oxychlorination gas 73. A mixing box is arranged between the oxychlorination zone and the calcination zone, at least one space 85 for catalyst grains to pass being made between the box and the chamber 2, with the mixing box comprising an inner space 80 surrounded by a gas-tight side wall 84, a gas-permeable bottom 83, and a roof 81 that covers the inner space 80. The pipe 73 for introducing oxychlorination gas empties into the inner space 80. The mixing box comprises means 82 for evacuating gas, whereby these means are arranged between said vertical wall 84 and the roof 81.

This invention relates to the field of the conversion of hydrocarbons and more specifically of the reforming of hydrocarbon-containing feedstocks in the presence of a moving-bed catalyst for producing gasoline fractions. This invention proposes a catalyst regeneration reactor with a box for mixing the calcination and oxychlorination gases and for distributing the gas in the oxychlorination zone of the catalyst.

The processes for catalytic reforming of gasolines operating in a moving bed generally implement a reaction zone that can comprise three or four reactors in a series and a catalyst regeneration zone that implements a certain number of stages, in general a combustion stage, an oxychlorination stage, followed by a calcination stage and a reduction stage. The document U.S. Pat. No. 3,761,390 describes a sample embodiment of a catalytic reforming process operating in a moving bed.

The document U.S. Pat. No. 7,985,381 describes in detail a regeneration reactor that comprises a combustion zone, an oxychlorination zone, and a calcination zone. The catalyst circulates in a downward vertical direction in the reactor. It passes from the oxychlorination zone to the calcination zone via an annular ring. A calcination gas that is injected at the bottom of the calcination zone passes through, in countercurrent, the catalyst bed into the calcination zone and then is recovered in a second annular zone located on the periphery of the reactor. In this second annular zone, the oxychlorination gas is injected to be mixed with the calcination gas that has been recovered. The gas mixture is then injected on the periphery of the reactor at the bottom of the oxychlorination zone.

The injection of this gas mixture on the periphery of the reactor has the drawback of generating a speed profile of the non-homogeneous gas at the outlet of the injection zone on the cross-section of the oxychlorination zone. In addition, the passage of the catalyst from the oxychlorination zone to the calcination zone via an annular ring is cumbersome in the reactor and generates pressure drops. Nevertheless, the pressure drops are not sufficient to prevent calcination gas from rising directly via the downward legs of the catalyst without passing into the external annular ring and therefore without being mixed with the calcination gas.

This invention proposes to optimize the mixing of the oxychlorination gas with the calcination gas by using a central mixing box.

In a general manner, the reactor for continuous regeneration of catalyst grains consists of a chamber that comprises an oxychlorination zone superposed on a calcination zone that is equipped with a pipe for introducing calcination gas. The reactor is characterized in that a mixing box is arranged between the oxychlorination zone and the calcination zone, with at least one space for catalyst grains to pass being made between the box and the chamber. The mixing box comprising an inner space surrounded by a gas-tight side wall, a gas-permeable bottom, and a roof covering said inner space, with the roof being sealed against catalyst grains [sic]. The reactor also comprises a pipe for injecting oxychlorination gas that empties into the inner space. The mixing box comprises means for evacuating gas, with said means being arranged between said side wall and the roof.

According to the invention, the side wall can form a vertical cylinder, with said gas evacuation means being arranged on a surface in a ring that extends the vertical cylinder up to the roof.

The chamber can comprise a collar that reduces the horizontal cross-section of the chamber at the level of the mixing box relative to the horizontal cross-section of the oxychlorination zone.

The roof can be selected from among a cone, a pyramid, or a dome, whose peak points upward.

The pipe for injecting oxychlorination gas can empty into the inner space at the level of the side wall.

The pipe for injecting oxychlorination gas can empty into the middle of the inner space.

The inner space can comprise at least one of the following mixing means: a deflecting plate, a grid.

The bottom of the mixing box can comprise a gas-permeable plate.

The horizontal cross-section of the inner zone can be at least greater than 10% of the horizontal cross-section of the chamber measured at the level of the mixing box, and the horizontal cross-section of the passage space can be between 0.2% and 20% of the horizontal cross-section of the inner zone.

The reactor according to the invention can be used in a process for catalytic reforming of a hydrocarbon feedstock, in which:
A stream of catalyst grains is introduced at the top of the oxychlorination zone,
A stream of calcination gas is introduced via the pipe for introducing calcination gas,
A stream of oxychlorination gas is introduced via the pipe for injecting oxychlorination gas,
A stream of gas is evacuated at the top of the oxychlorination zone,
A stream of catalyst grains is evacuated at the bottom of the calcination zone.

The catalyst grains can comprise platinum deposited on a porous substrate, the stream of calcination gas can comprise air and can be at a temperature of between 400° C. and 550° C., and the stream of oxychlorination gas can comprise a chlorinated compound and can be at a temperature of between 350° C. and 550° C.

It is possible to carry out a remodeling of a reactor that exists by replacing the old oxychlorination gas injection system by said mixing box according to the invention.

According to the invention, the fact of mixing the calcination gas with the oxychlorination gas in the mixing box that is lacking in catalyst grain makes it possible to obtain a good gas mixture.

In addition, the distribution of gas over a ring arranged in the center of the chamber of the reactor ensures an excellent distribution of the gas mixture over the entire cross-section of the reactor.

In addition, this invention can be easily implemented in existing installations. In particular, this invention can advantageously replace an oxychlorination gas injection device so as to improve its mixing and distribution performances.

### BRIEF DESCRIPTION OF DRAWINGS

Other characteristics and advantages of the invention will be better understood and will appear clearly from reading the description given below by referring to the drawings, among which:

FIG. 1 shows a catalyst regeneration reactor,

FIG. 2 shows in detail an embodiment of the mixing zone according to the invention,

FIG. 3 shows a cutaway view of the mixing box,

FIG. 4 shows a cutaway view of the mixing box, according to another embodiment.

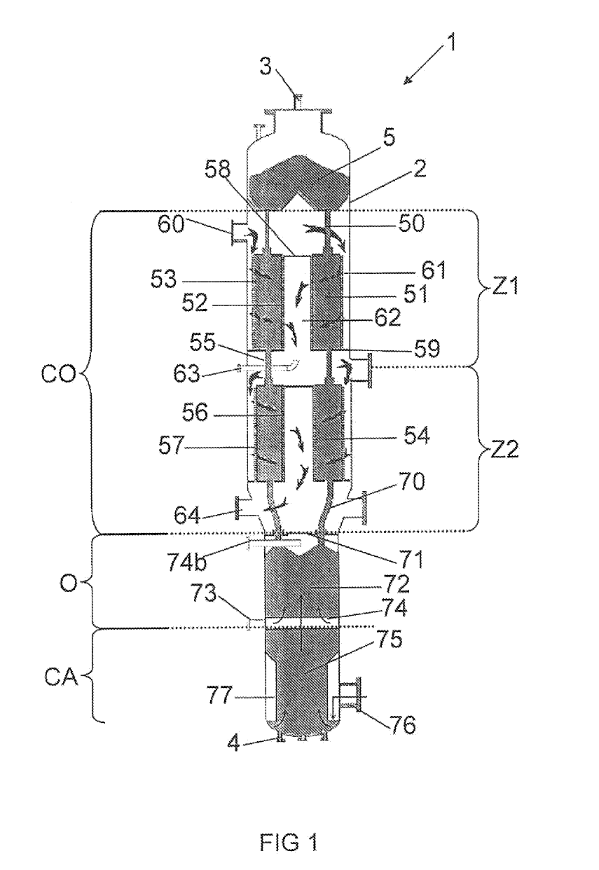

In FIG. 1, the catalyst regeneration reactor consists of a chamber 2 that contains a combustion zone CO, an oxychlorination zone O, and a calcination zone CA. The chamber 2 can be in the form of a vertical axis cylinder, with the cylinder being closed at its ends. The zones for combustion, oxychlorination, and calcination are superposed in the reactor 1. In the reactor 1, these zones can have the same diameter or different diameters.

The catalyst that is to be regenerated is introduced at the top of the reactor 1 by the pipe(s) 3 and is evacuated from the reactor 1 via the pipes 4 that are located at the bottom of the reactor 1. Under the effect of gravity, the catalyst circulates from top to bottom in the reactor by successively passing through the zones for combustion CO, oxychlorination O, and calcination CA. The catalyst is evacuated from the reactor 1 at the bottom of the calcination zone CA via the pipes 4. The reactor 1 is continuously supplied with catalyst, and the catalyst circulates continuously in the reactor 1.

The catalyst is in the form of solid grain, for example in ball form having between 0.5 mm and 20 mm in diameter so as to facilitate the circulation of the catalyst in the reactor 1. The catalyst grains consist of a porous substrate, for example an alumina, on which different compounds—in particular platinum and chlorine, and optionally tin, rhenium, indium and/or phosphorus—have been deposited. The catalyst that is to be regenerated comprises coke, for example approximately 5% by weight of coke.

The catalyst that is introduced by the pipe 3 into the reactor 1 comes into a tank 5 that is equipped with a hopper that makes it possible to supply the combustion zone CO with catalyst.

The combustion zone CO has as its object to carry out the combustion of the coke deposited on the catalyst. The zone CO can comprise one or more stages. The reactor 1 of FIG. 1 comprises two stages Z1 and Z2. According to a particular embodiment, the combustion zone can also comprise a combustion monitoring zone, for example as described by the document FR 2761907. The catalyst of the tank 5 is introduced into an annular space 51 of stage Z1 via the feed pipes 50. The annular space 51 is delimited by two tubular grids 52 and 53, for example cylindrical and concentric. The space 61 that is located between the tubular grid 53 and the chamber 2 is blocked at its lower end by the plate 59. The space 61 can be arranged in the form of portions commonly named “scallops.” The central space 62 that is located inside the tubular grid 52 is blocked at its upper end by the plate 58. The catalyst of the annular space 51 is introduced into an annular space 54 of stage Z2 via the feed pipes 55. The space 54 is delimited by two tubular grids 56 and 57, for example cylindrical and concentric. The grids 52, 53, 56 and 57 make it possible to retain the catalyst while allowing gas to pass. For example, the grids 52, 53, 56 and 57 can be Johnson grids and/or perforated plates.

A first stream of combustion gas containing oxygen is introduced into the chamber 2 at the top of stage Z1 via the opening 60. In stage Z1, the stream of gas circulates according to the arrows that are indicated in FIG. 1 by passing through the catalyst bed contained in the annular space 51. Actually, the airtight plates 58 and 59 force the combustion gas coming in via the opening 60 to pass from the space 61 onto the periphery of the annular space 51 to the central space 62 located inside the grid 52 by passing through the catalyst into the annular space 51. A second stream of combustion gas containing oxygen is introduced between stages Z1 and Z2 via the pipe 63. This second stream mixes with the first gas stream that has passed through stage Z1. In the same way as for stage Z2, the combustion gas passes through the catalyst bed contained in the annular space 54, according to the arrows that are indicated in FIG. 1. After having passed through the catalyst of zone 54, the combustion gas is evacuated from stage Z2 via the pipe 64.

According to another embodiment, the combustion zone CO can be arranged in such a way that the combustion gas circulates from the inside to the outside into the annular spaces 51 and 54. In addition, alternatively, according to another embodiment, the combustion zone can be arranged in such a way that the movement of the gas is injected at the bottom of the zone CO and is evacuated at the top of the zone CO.

The catalyst in the annular zone 54 of the combustion zone flows from the combustion zone CO into the oxychlorination zone O via the pipes 70. The plate 71 that is arranged between the combustion zone and the oxychlorination zone O is gas-tight to prevent the circulation of gas between these two zones.

In particular, the oxychlorination zone O has as its object to recharge the catalyst grains with chlorine and to redisperse the platinum on its surface so as to improve the distribution of the platinum in the catalyst grains. In the oxychlorination zone O, the catalyst flows into the space 72 inside the reactor, for example the cylindrical space defined by the walls of the chamber 2 of the reactor. The bottom of the space 72 of the oxychlorination zone O is equipped with the pipe 73 that makes it possible to inject the oxychlorination gas into the oxychlorination zone. The oxychlorination gas comprises a chlorine-containing compound and can be at a temperature of between 350° C. and 550° C., preferably between 460° C. and 530° C. At the top of the space 72, the pipe 74b makes it possible to evacuate the gas from the oxychlorination zone O. The oxychlorination gas that is injected via the pipe 73 circulates in an upward direction through the space 72, in countercurrent to the gravity flow of the catalyst. Then, the gas that has passed through the space 72 is evacuated from the chamber 2 via the pipe 74b.

The catalyst that comes in at the bottom of the oxychlorination zone O continues to flow from the space 72 to the space 75 of the calcination zone CA. The calcination zone in particular has as its object to dry the catalyst grains. The bottom of the calcination zone CA is equipped with the pipe 76 that makes it possible to inject the calcination gas at the bottom of the space 75. The calcination gas comprises air or oxygen-depleted air and can be at a temperature of between 400° C. and 550° C. So as to distribute in a homogeneous manner the calcination gas in the space 75, the pipe 76 can empty into an annular space 77 that is arranged on the periphery, between the space 75 and the chamber 2. The annular space 77 is open in its low part located at the bottom of the space 75 of the calcination zone CA. Thus, the gas that is injected via the pipe 76 is distributed in the catalyst bed over the entire periphery at the bottom of the space 75. The calcination gas that is injected via the pipe 76 circulates in an upward direction, in counter-current to the gravity flow of the catalyst, through the space 75, and then through the space 72. When the calcined gas passes from the space 75 to the space 72, it encounters—and mixes with—the oxychlorination gas that is injected via the pipe 73. Then, the gas that has passed through the space 72 is evacuated from the chamber 2 via the pipe 74b.

According to the invention, a mixing zone 74 is arranged between the space 72 and the space 75. The mixing zone 74 comprises a central mixing box that is designed so as to carry out a homogeneous mixing of the calcination gas with the oxychlorination gas and to distribute the gas mixture in a homogeneous manner over the entire cross-section of the space 72.

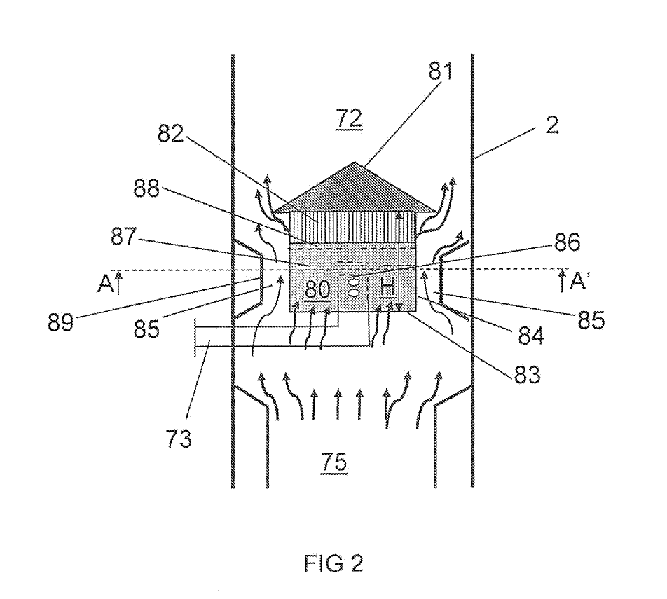

The mixing zone 74 is described in detail with reference to FIG. 2. The references of FIG. 2 that are identical to those of FIG. 1 refer to the same elements.

With reference to FIG. 2, the mixing zone 74 consists of a mixing box that is positioned between the space 72 of the oxychlorination zone and the space 75 of the calcination zone.

The mixing box consists of an inner space 80 that is delimited by a side wall 84 and a roof 81. The side wall 84 can have the shape of a vertical cylinder portion, sealed against the catalyst grain and preferably gas-tight. The roof 81 covers at least the horizontal cross-section of the inner space 80 by being sealed against the catalyst grain. The roof 81 is sealed against catalyst grains and is optionally gas-tight. The roof 81 can be in the shape of a dome, cone or pyramid so as to deflect the flow of catalyst grains around the mixing box. Thus, the roof 81 that is combined with the side wall 84 makes it possible to prevent the presence of catalyst in the inner space 80. The catalyst flows into the space 85 that is located between the mixing box and the walls of the chamber 2. The catalyst flows into the space 85 from the space 72 of the oxychlorination zone into the space 75 of the calcination zone. In addition, the mixing box comprises gas evacuation means 82, which are arranged between the side wall 84 and the roof 81. To preserve an adequate volume for producing a good mixture of gas in the mixing box, the height H corresponding to the sum of the height of the wall 84 and the gas evacuation means 82 can be encompassed between 50 and 500 mm, preferably between 150 and 400 mm.

The oxychlorination gas feed pipe 73 empties into the inner space 80 of the mixing box. The bottom 83 of the mixing box is gas-permeable. For example, the bottom of the mixing box is open. Thus, the calcination gas that circulates in an upward vertical direction in the space 75 empties into the inner space 80 of the mixing box. Alternatively, it is possible to arrange a gas-permeable plate 83 on the bottom of the inner space 80. The plate 83, for example a grid or a perforated plate, allows the gas to pass from the space 75 of the calcination zone into the inner space 80 of the mixing box. The grid or perforated plate makes it possible to introduce the oxychlorination gas into the inner space 80 at high speed without entraining solid catalyst bed particles from the space 75 into the inner zone 80. In addition, the plate or grid 83 can be used to reinforce the mechanical behavior of the mixing box by making the side wall 84 integral with the plate or grid 83.

Therefore, the mixing of the calcination gas with the oxychlorination gas in the inner space 80 that is lacking in catalyst grain is carried out, which makes it possible to obtain a good gas mixture.

Preferably, the pipe 73 is arranged to empty into the middle of the inner space 80 of the mixing box. For example, the pipe 73 can pass below the mixing box by passing through the bottom 83 as shown by FIG. 2. Alternatively, the pipe 73 can pass above the mixing box by passing through the roof 81. Alternatively, the pipe 73 can pass directly through the side wall 84 of the mixing box. These configurations make it possible to inject the oxychlorination gas into the middle of the inner space 80 so that it can be distributed in a homogeneous manner within the entire inner space 80. According to another embodiment, the pipe 73 can be essentially horizontal by passing through the side wall 84 and by emptying into the zone 80 at the wall 84. The fact of injecting the oxychlorination gas in a lateral manner through the horizontal pipe 73 makes it possible to carry out an excellent mixing with the calcination gas circulating in cross-current relative to the oxychlorination gas that is injected horizontally via the pipe 73. In addition, the pipe 73 can be used to reinforce the mechanical behavior of the mixing box by making said pipe integral with at least one of the following elements: the side wall 84, the plate or grid 83 or the roof 81.

For the different embodiments of the pipe 73 that empties into the center or at the wall of the mixing box, the end of the pipe 73 that empties into the inner space 80 of the mixing box can be equipped with several perforations 86 so as to diffuse the oxychlorination gas in different directions in the inner space 80 and therefore to improve gas mixing.

Alternatively, it is possible to use several pipes 73 for injecting the oxychlorination gas into the mixing box. In this case, the pipes can empty into different locations in the mixing box. Furthermore, the end of the pipe 73 can be extended by several branches into the inner space 80 of the mixing box for injecting oxychlorination gas at different locations in the mixing box.

In addition, to improve gas mixing, it is possible to arrange internal elements in the inner space 80 of the mixing box, for example deflecting plates 87 and/or a perforated grid 88 that break up the jets of oxychlorination gas injected through the openings 86 of the pipe 73 and that promote the mixing with the calcination gas.

The mixing box comprises a gas evacuation means 82 positioned between the side wall 84 and the roof 81. For example, the means 82 can be a perforated plate, a Johnson grid, or any other means allowing the gas to pass and preventing the catalyst grain from passing. The mixture of calcination gas and oxychlorination gas obtained in the inner space 80 is evacuated and distributed by the gas evacuation means 82. The means 82 can be distributed over a surface in rings that extend the side wall 84 up to the roof 81. For example, the means 82 can be a perforated plate, a Johnson grid, or any other means allowing the gas to pass and preventing the catalyst grain from passing. Preferably, the perforated plate or the Johnson grid 82 is arranged vertically, for example, in the form of a cylinder that extends the cylinder that is formed by the side wall 84, for promoting the flow of catalyst grains along the perforated plate or the Johnson grid 82 and for preventing the blocking and the deposition of catalyst fragments against the plate or the grid 82. Thus, the gas mixture is distributed over an annular surface corresponding to the outside surface of the perforated plate or the Johnson grid 82. Given that this annular surface is located essentially in the middle of the chamber 2, the gas mixture is well distributed over the entire cross-section of the chamber 2 (I leave it up to you to refine the explanation, if necessary).

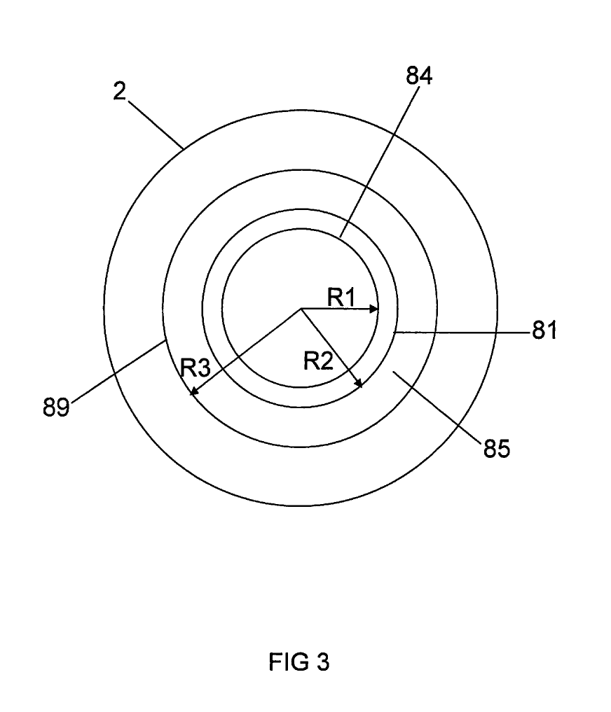

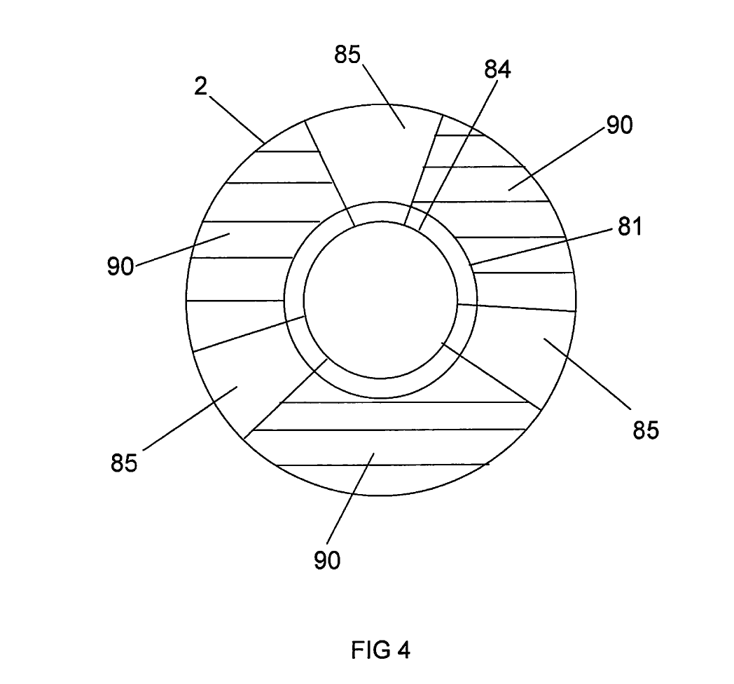

Furthermore, the horizontal cross-section of the space 85 can be determined for ensuring the flow of grains while minimizing the amount of calcination gas circulating directly from the calcination zone to the oxychlorination zone without passing through the inner space 80 of the mixing box. According to a first embodiment that is described below with reference to FIG. 3, it is possible to use a means for reducing the cross-section of the reactor at the mixing box so as to minimize the horizontal cross-section of the space 85. According to a second embodiment described below with reference to FIG. 4, it is possible to envision sealing the quarters of the cross-section of the horizontal cross-section between the mixing box and the chamber 2 of the reactor.

FIG. 3 shows a cutaway along the axis AA′ of the mixing box of FIG. 2. The references of FIG. 3 that are identical to the one of FIG. 2 refer to the same elements. With reference to FIG. 3, the roof is in the shape of a cone or a dome whose base forms a circle with radius R2. The side wall 84 has the shape of a cylinder with radius R1. The collar 89 forms a chokepoint of the chamber 2 around the mixing box with a cylinder with radius R3. The space 85 consequently forms an annular space between the collar 89 with radius R3 and the side wall 84 with radius R1.

FIG. 4 shows a cutaway along the axis AA′ of the mixing box of FIG. 2, in which the collar 89 has been removed. The references of FIG. 4 that are identical to those of FIG. 2 refer to the same elements. With reference to FIG. 4, the mixing box is connected to the chamber 2 of the reactor by three plates 90. Each of the plates 90, which preferably extend along a horizontal plane, blocks the passage of catalyst between the mixing box and the chamber 2. The catalyst grains circulate in the spaces 85 that are each located between two plates 90. Without exceeding the scope of this invention, it is possible to adjust the number and the dimensions of the plates 90.

According to the invention, preferably the horizontal cross-section that is covered by the roof is greater, for example by at least 5%, and even 10%, than the cross-section of the inner space 80 of the mixing box, so as to limit the presence of catalyst at the level of the gas evacuation means 82. For example, with reference to FIG. 3, the radii R1 and R3 are selected in such a way that (R2−R1)/R1 is at least 5%, and even 10%.

According to the invention, to ensure a good mixing and to collect a large amount of the calcination gas stream coming from the space 75 of the calcination zone, the horizontal cross-section of the inner space 80 of the mixing box is at least greater than 10% of the horizontal cross-section of the reactor 1 at the mixing box. In the embodiment of FIG. 3, the radii R1 and R3 are selected in such a manner that R1²>R3²*0.1.

In addition, the horizontal cross-section of the space 85 can be encompassed between 0.2% and 20%, preferably between 1% and 10%, of the horizontal cross-section of the inner space 80. To adjust the cross-section of the annular space 85, the chamber 2 can comprise a collar 89 at the level of the mixing box. The collar 89 generates a chokepoint of the cross-section of the chamber 2 at the level of the mixing box and therefore reduces the horizontal cross-section of the annular space 85. In the example of FIG. 3, the radii R1 and R3 are selected in such a manner that (R3²−R1²)/R1² is encompassed between 0.2% and 20%, preferably between 1 and 10%. In the embodiment of FIG. 4, the size and the number of plates 90 are adjusted to allow an adequate surface area in the spaces 85 that are available to the passage of catalyst grains and to limit the passage of calcination gas via the spaces 85.

In addition, to prevent the blocking of catalyst grains in the space 85, the maximum distance separating the side wall 84 from the wall of the chamber 2 can be at least greater than or equal to 1″ (25.4 mm), preferably 2″ (50.8 mm). In the example of FIG. 3, the radii R1 and R3 are selected in such a way that the distance R3−R1 is greater than or equal to 1″ (25.4 mm), preferably 2″ (50.8 mm).

The simplicity of the mixing box and the reduced dimensions of the mixing box, in particular the small height requirement relative to the size of the reactor, make it possible to use the mixing box according to the invention within the framework of a remodeling of an installation, commonly called “revamping.” Actually, it is possible to install the mixing box that consists of the side wall 84, the roof 81, and the gas evacuation means 82, and the pipe 73 for supplying oxychlorination gas instead of another system in an existing reactor, for example, a reactor that is described by the document U.S. Pat. No. 7,985,381.

Thus, the mixing zone 74 that is equipped with the mixing box according to the invention makes it possible to carry out a homogeneous mixing between the calcination gas with the oxychlorination gas and makes it possible to distribute this gas mixture in a homogeneous manner over the entire cross-section of the oxychlorination zone.

The entire disclosures of all applications, patents, and publications, cited herein and of corresponding application Ser. No. 12/01.887 FR, filed Jul. 4, 2012 are incorporated by reference herein.

1) Reactor for continuous regeneration of catalyst grains, composed of a chamber (2) that comprises an oxychlorination zone (72) superposed on a calcination zone (75) that is equipped with a pipe for introducing calcination gas, characterized in that a mixing box is arranged between the oxychlorination zone (72) and the calcination zone (75), at least one space (85) for the catalyst grains to pass being made between the box and the chamber (2), with the mixing box comprising an inner space (80) surrounded by a gas-tight side wall (84), a gas-permeable bottom (83) and a roof (81) that covers said inner space (80), with the roof (81) being sealed against catalyst grains, the reactor comprising an oxychlorination gas injection pipe (73) that empties into the inner space (80), the mixing box comprising gas evacuation means (82), with said means (82) being arranged between said side wall (84) and the roof.

2) Reactor according to claim 1, wherein the side wall (84) forms a vertical cylinder, with said gas evacuation means (82) being arranged over a surface in a ring that extends the vertical cylinder up to the roof (81).

3) Reactor according to one of claims 1 and 2, wherein the chamber (2) comprises a collar (89) that reduces the horizontal cross-section of the chamber (2) at the level of the mixing box relative to the horizontal cross-section of the oxychlorination zone (72).

4) Reactor according to one of claims 1 to 3, wherein the roof (81) is selected from among a cone, a pyramid or a dome, whose peak points upward.

5) Reactor according to one of claims 1 to 4, wherein the oxychlorination gas injection pipe (73) empties into the inner space (80) at the level of the side wall (84).

6) Reactor according to one of claims 1 to 4, wherein the oxychlorination gas injection pipe (73) empties into the middle of the inner space (80).

7) Reactor according to one of claims 5 and 6, wherein the inner space (80) comprises at least one of the following mixing means (87; 88): a deflecting plate, a grid.

8) Reactor according to one of claims 1 to 7, wherein the bottom of the mixing box (83) comprises a gas-permeable plate.

9) Reactor according to claim 8, wherein the horizontal cross-section of the inner zone is at least greater than 10% of the horizontal cross-section of the chamber that is measured at the level of the mixing box and wherein the horizontal cross-section of the passage space is between 0.2% and 20% of the horizontal cross-section of the inner zone.

10) Use of the reactor according to one of the preceding claims in a process for catalytic reforming of a hydrocarbon feedstock, wherein:
A stream of catalyst grains is introduced at the top of the oxychlorination zone (72),
A stream of calcination gas is introduced via the pipe for introducing calcination gas,
A stream of oxychlorination gas is introduced via the oxychlorination gas injection pipe (73),
A stream of gas is evacuated at the top of the oxychlorination zone,
A stream of catalyst grains is evacuated at the bottom of the calcination zone.

11) Use according to claim 10, wherein the catalyst grains comprise platinum that is deposited on a porous substrate, the calcination gas stream comprises air and is at a temperature of between 400° C. and 550° C., and the oxychlorination gas stream comprises a chlorine-containing compound and is at a temperature of between 350° C. and 550° C.

12) Process for obtaining a reactor according to one of claims 1 to 9, wherein a remodeling of an existing reactor is carried out by replacing the old oxychlorination gas injection system by said mixing box.
